(19) United States
(12) Patent Application Publication
(10) Pub. No.: US 2022/0374275 A1
(43) Pub. Date: Nov. 24, 2022

(54) SYSTEM FOR RESOURCE ADMINISTRATION IN AN INSTALLATION FOR AUTOMATION ENGINEERING

(71) Applicant: Endress+Hauser SE+Co. KG, Maulburg (DE)

(72) Inventors: Werner Thoren, Steinen (DE); Eric Birgel, Schopfheim (DE); Harald Schäuble, Lörrach (DE); Nikolai Fink, Aesch (CH); Aurelia Erhardt, Reinach (CH); Holger Eberhard, Stuttgart (DE)

(21) Appl. No.: 17/755,730

(22) PCT Filed: Nov. 2, 2020
(86) PCT No.: PCT/EP2020/080642

§ 371 Date: May 6, 2022

(30) Foreign Application Priority Data
Nov. 6, 2019 (DE) 10 2019 129 969.1

(51) Int. Cl. G06F 9/50

(52) U.S. Cl. CPC G06F 9/5027; G06F 9/5016

(57) ABSTRACT

The disclosure relates to a system for resource administration in automation engineering. A field device is designed to record and/or influence process variables and is communicatively connected to an edge device and supplies raw data of the current measured value of the process or control variables. The edge device is communicatively connected to a service platform via a second communication network. In a container portion, a plurality of logic/application components are held which allow specific measurement and diagnosis capabilities to be executed. Based on the computing resources or storage resources provided in the field devices, in the edge device and in the service platform, the logic/application components can be loaded onto the respective devices and executed by the corresponding execution units of the devices.

The invention relates to a system for resource administration in an installation of automation technology.

Field devices that are used in industrial automation technology systems are already known from the prior art. Field devices are often used in process automation as well as in manufacturing automation. Field devices, in principle, refer to all devices that are used in-process and that supply or process process-relevant information. Field devices are thus used for capturing and/or influencing process variables. Sensor units are used for capturing process variables. These are used, for example, for pressure and temperature measurement, conductivity measurement, flow measurement, pH measurement, fill-level measurement, etc., and capture the corresponding process variables of pressure, temperature, conductivity, pH value, fill level, flow, etc. Actuator systems are used for influencing process variables. These are, for example, pumps or valves that can influence the flow of a fluid in a pipe or the fill level in a tank. In addition to the aforementioned measuring devices and actuators, field devices are also understood to include remote I/O's, radio adapters, or, generally, devices that are arranged at the field level.

A variety of such field devices is produced and marketed by the Endress+Hauser group.

Field devices, such as are known today, usually have measuring transducer electronics in addition to the sensors and/or actuators. This serves the purpose of processing collected measurement signals from the sensors or actuating signals from the actuators and converting them into a measured value, or into additional information derived therefrom (for example an envelope curve) or into a manipulated variable. For this purpose, the field device has parameters that set the field device to the respective application.

Field devices available nowadays sometimes have a large number of parameters, so that parametrization is a complex and error-prone process (due to incorrectly set parameter values), which also entails a high outlay on testing. Replacing a field device is complicated, since the replacement device must be given the same parametrization as the field device to be replaced. This can also lead to an information loss if not all of the parameter values are set correctly.

The software of the measuring transducer electronics is kept essentially static and is only rarely renewed by updates. These updates are often used to fix errors. However, the scope of functions enabled by the software remains essentially identical and cannot be expanded. In addition, field devices are limited in their resources so that often only small memory and performance resources are present. Even if an update of the software were able to add further functions, as described for example in patent application DE 10 2012 112 842, their functional complexity would be low due to the limited memory and performance resources of the field device.

In addition, the field devices are not upwardly compatible. For example, if new field device generation comes onto the market, this will often have increased memory and performance resources. The functional scope of the software of the measuring transducer electronics can be increased here, for example by improved measurement and evaluation algorithms, since more resources are available. However, this version of the software will not be compatible with the older field devices, since these have lower memory and performance resources.

It has become known from DE 10 2011 006 989 A1 and from DE 10 2013 103 212 A1 that field devices output only raw data via a communication network, i.e., for example, measurement signals and/or actuating signals that are processed only to a basic extent by measurement and evaluation algorithms. Calculation of the measured values or the manipulated variables then takes place in a network component other than the field device, for example in a cloud. Here, however, the problem arises that the measured values or manipulated variables cannot be available in real time, which is not suitable for time-critical applications. However, this does not solve the updating problems of the software of the measuring transducer electronics.

Proceeding from this problem, the object of the invention is to provide a system that makes it possible to simplify the adaptability of the field devices to processes and to ensure that future measurement and evaluation algorithms can be used with the existing field devices in the field.

The object is achieved by a system for resource administration in an installation of automation technology, comprising:
a server platform having a container portion, a management portion and an execution unit, wherein the container portion has a plurality of logic/application components, wherein a logic/application component contains algorithms or instructions for executing functions and wherein a logic/application component requires a minimum computing resource or memory resource in order to be executable on a device, and wherein the execution unit provides a defined computing resource or memory resource and is configured to instantiate or execute at least one logic/application component;
at least one field device, which is integrated in a field level of the installation in a first communication network, with at least one sensor unit and/or an actuator unit and an execution unit,
wherein the sensor unit is designed to capture a physical or chemical measured variable of a process-engineering process,
wherein the actuator unit is designed to influence a physical or chemical measured variable of a process-engineering process,
wherein the field device is designed to output as raw data the measured variable captured by the sensor unit and/or a manipulated variable of the actuator unit, and
wherein the execution unit provides a defined computing resource or memory resource and is designed to instantiate or execute at least one logic/application component;
an edge device, which is connected to the first communication network and which is directly or indirectly in communication with the server platform by means of a second communication network,
with a communication unit and an execution unit,
wherein the communication unit is designed to exchange data between the edge device, the field device and the server platform,
wherein the execution unit provides a defined computing resource or memory resource and is designed to instantiate or execute at least one logic/application component, and wherein the management portion of the server platform is designed, after selection by an operator, to assign one of the logic/application components to the field device, the edge device or the server platform, according to the minimum computing resource or memory resource required, and to load them onto this or these and to instruct them to instantiate the logic/application component.

Examples of field devices that are used in the system according to the invention have already been described in the introductory part of the description.

According to an advantageous development of the system according to the invention, it is provided that the sizes of the provided computing resources or computing memory resources, of the field device, of the edge devices, and of the server platform differ from one another, wherein the field device has the smallest size of the computing resources or memory resources provided and wherein the server platform has the largest size of the computing resources or memory resources provided.

According to a preferred development of the system according to the invention, it is provided that, in the event that the logic/application components can also be instantiated on the edge device and/or on the field device apart from on the server platform, the operator will be given a selection option via the instantiating component.

According to an advantageous development of the system according to the invention, it is provided that, in the event that a logic/application component is to be instantiated on the field device or on the edge device, even though the field device or the edge device cannot provide the required minimum computing resource or memory resource, the management portion is designed to distribute the logic/application component among the execution units of the field device and of the edge device or of a plurality of field devices or of a plurality of edge devices and to cause them to be instantiated together.

According to a preferred development of the system according to the invention, it is provided that the management portion is designed to manage license information of the operator and to instantiate at least some of the logic/application components only for a specific time in accordance with the license information on the corresponding execution unit.

According to an advantageous development of the system according to the invention, it is provided that, in the event of an exchange or the new addition of an edge device and/or field device, the management portion is designed to automatically assign corresponding logic/application components to the new edge device or field device, in particular analogously to the edge device or field device to be replaced or according to an operator profile.

According to a preferred development of the system according to the invention, it is provided that the first communication network is an Ethernet-based communication network or a field bus network of automation technology, or is based on the HART protocol, wherein the first communication network is designed to be wireless or wired.

According to an advantageous development of the system according to the invention, it is provided that the edge device is in communication with the server platform by means of the Internet as a second communication network.

According to a preferred development of the system according to the invention, it is provided that the edge device is connected to an additional device via a data connection, in particular a wireless data connection, and wherein the additional device can be connected to the server platform by means of an Internet connection and is designed to establish the communication connection between the edge device and the server platform.

According to an advantageous development of the system according to the invention, it is provided that the edge device is in communication connection with the server platform only at those times when a logic/application component is assigned to the edge device and/or to the field device and wherein the communication connection is terminated after the assignment or the initiation of the instantiation.

According to a preferred development of the system according to the invention, it is provided that corresponding execution units are assigned to the edge device or to the field device in a plurality of versions of the same logic/application component, and wherein only that logic/application component that is released by the management portion of the server platform can be instantiated.

According to an advantageous development of the system according to the invention, it is provided that the server platform is designed to be cloud-based.

According to a preferred development of the system according to the invention, it is provided that a logic/application component executes one of the following logic operations or applications:
processing raw data of the field device, in particular calculating and/or evaluating envelope curves;
processing raw data of the field device together with raw data of at least one further field device;
logging raw data of the field device;
diagnostic functionalities;
communication components, in particular network-specific communication components;
parametrizations of the corresponding device, the execution unit of which instantiates or executes the logic/application component.

The raw data of a plurality of field devices can be processed together in order to obtain, for example, values process variables that cannot be captured by any of the individual field devices. A plurality of combinations of primary process variables is known under the keywords “sensor fusion” in order to be able to calculate secondary process variables.

The invention is explained in greater detail with reference to the following FIGURE. The following are illustrated:

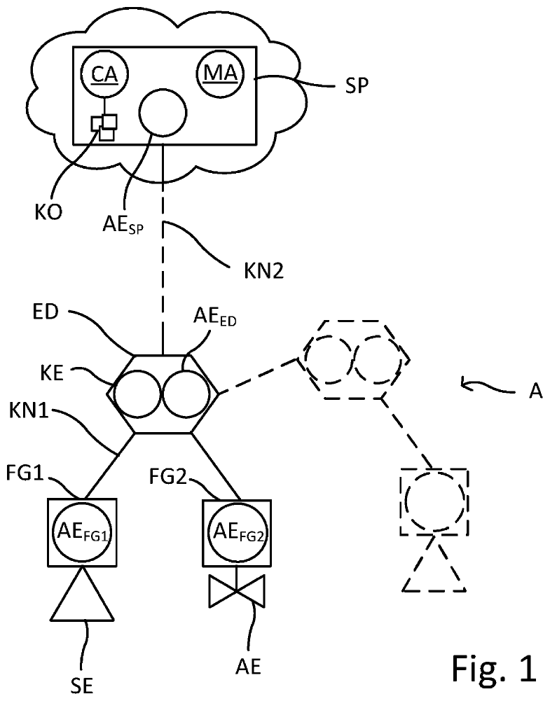

FIG. 1: a schematic overview of the system according to the invention.

FIG. 1 shows a system according to the invention. A plurality of field devices FG1, FG2 are integrated into an installation A of automation technology. In the specific case, the field device FG1 is a fill-level measurement device that measures the fill level of a measurement medium in a container by means of a radar-based sensor unit SE. The field device FG2 is an actuator whose actuator unit AE is a valve by means of which the inflow into the container is regulated. The field devices FG1, FG2 are connected to an edge device ED by means of a first communication network KN1, for example a field bus of automation technology (Profibus PA, Foundation Fieldbus, etc.) or based on HART, e.g. HART Multidrop. Here, the first communication network can be wired or wireless, for example with a corresponding wireless field bus standard.

Further edge devices can be provided in the installation A, which can be in communication with further field devices (shown by dashed lines in FIG. 1). The edge devices can also be in communication with one another and exchange data.

Both the field devices FG1, FG2 and the edge device ED comprise so-called execution units AE_{FG1}, AE_{FG2}, AE_{ED}. These execution units AE_{FG1}, AE_{FG2}, AE_{ED} are electronic units with software containers into which logic/application components KO can be loaded. The logic/application components KO contain and permit the execution of functionalities, which extend the basic functionalities of the field devices FG1, FG2 or of the edge device ED. The field devices FG1, FG2 and the edge device ED each represent defined computing resources or memory resources. The computing resources are provided, for example, by microprocessors and/or ASICs. The memory resources are provided, for example, by volatile and/or non-volatile (working) memory modules. Typically, greater computing resources or memory resources can be provided in edge devices ED than in field devices FG1, FG2.

In order to execute the logic/application components KO in the intended execution units AE_{FG1}, AE_{FG2}, AE_{ED} provided, specific minimum requirements for the computing resources or memory resources apply. If these cannot be provided by the field device FG1, FG2 or by the edge device ED, the logic/application components KO will not be able to be executed.

The edge device is connected by means of a second communication network KN2, in particular the Internet, to a server platform SP, which is designed according to cloud-computing technology. The server platform SP comprises several components: On the one hand, the server platform SP comprises a container portion CA, in which a plurality of the logic/application components KO described above are stored. In addition, the server platform SP comprises a management portion MA, which manages the distribution of the logic/application components KO among the different field devices FG1, FG2 and edge devices ED in the installation A. On the other hand, the server platform contains its own execution unit AE_{ED} for executing the logic/application components KO on the server platform SP. The server platform SP can provide computing resources or memory resources as the field devices FG1, FG2 and the edge device ED.

On the part of an operator, logic/application components KO can be selected, which are to be used in the measurement equipment of the installation A where. The management application MA then initiates the transmission of the logic/application components KO to the respective measurement component FG1, FG2, ED, provided their computing resources or memory resources are sufficient, and initiates the instantiation of the transmitted logic/application components KO in the corresponding execution unit AE_{SP}, AE_{FG1}, AE_{FG2}, AE_{ED}.

Two application examples that can be realized by means of the system according to the invention are described below:

In the first exemplary development, the installation section shown in FIG. 1 is constructed or put into operation for the first time. The field devices FG1, FG2 and the edge device edge device are shipped and installed as intended in the installation A and connected to one another.

The field devices FG1, FG2 are supplied with a first version of a special logic/application component KO, which by execution in the respective execution unit AE_{FG1}, AE_{FG2} enables extended diagnostics functionalities. These diagnostic functionalities, which are implemented, for example, in field devices of the applicant that have the name “Heartbeat”, enable a verification of the hardware components of the field devices FG1, FG2.

After some operating time, a new version of the logic/application component KO is provided by the manufacturer of the field devices FG1, FG2. This is loaded by the manufacturer into the container portion CA of the service platform. The operator, in this case the installation operator, is offered the update of the logic/application component KO. After a selection of the logic/application component KO, the management portion MA checks the executability of the new logic/application component KO in the execution units AE_{FG1}, AE_{FG2}. However, the latest version of the logic/application component KO requires resources that are too high and that the field devices FG1, FG2 cannot provide. However, the edge device ED does have these required resources. The management portion MA therefore initiates the loading of the new version of the logic/application component KO onto the edge device ED. The execution unit A_{ED} can then carry out the diagnostic functionalities by accessing the hardware components of the field devices FG1, FG2 via the first communication network.

After some further operating time, a further new version of the logic/application component KO is provided by the manufacturer of the field devices FG1, FG2. This is loaded by the manufacturer into the container portion CA of the service platform. The operator, in this case the installation operator, is offered the update of the logic/application component KO. After a selection of the logic/application component KO, the management portion MA checks the executability of the further new logic/application component KO in the execution units AE_{FG1}, AE_{FG2},AE_{ED}. However, the latest version of the logic/application component KO requires excessively high resources, which neither the field devices FG1, FG2 nor the edge device ED can provide. However, the service platform SP itself does have these required resources. The management portion MA therefore initiates the loading of the new version of the logic/application component KO into the execution unit AE_{SP} of the service platform SP. This can then carry out the diagnostic functionalities by accessing the hardware components of the field devices FG1, FG2 via the first and the second communication networks KN1, kN2.

The second application case also relates to the initial commissioning of the two field devices FG1, FG2. In this case, both field devices FG1, FG2 are of the same type, but are intended to perform different measurement tasks after start-up.

In a first step, the field devices FG1, FG2 are connected to the edge device ED via the first communication network KN1. The edge device ED recognizes the type of the field devices FG1, FG2. The edge device ED then registers both devices in the service platform SP and signals its device type or device identifier.

In a second part, the management portion MA of the service platform SP in each case loads onto the edge device ED a logic/application component KO for each of the field devices FG, FG2. By executing the logic/application components KO in the execution unit AE_{ED} a basic evaluation of the raw data transmitted by the field devices FG1, FG2 to the edge device ED is made possible.

In a third step, the operator selects on the service platform the respective measurement task for each of the field devices FG. Alternatively, the measurement task has already been preselected, or is automatically recognized and selected by the service platform SP, for example on the basis of environmental data of the respective field devices FG1, FG2. Alternatively, the measurement task has already been stored in the devices at the time of manufacture and is read out by the edge device ED and transmitted to the service platform SP.

In a fourth step, the management portion MA of the service platform SP loads specific logic/application components KO onto the edge device in accordance with the selected measurement task.

In measurement mode, the field devices FG1, FG2 now transmit to the edge device ED raw data relating to captured measured values. Corresponding to the specific logic/application components KO executed by the execution unit AE_{ED}, the raw data are processed or evaluated and transmitted to the service platform SP.

### LIST OF REFERENCE SIGNS

A Installation of automation technology
AE_{SP}, AE_{FG1}, AE_{FG2}, AE_{ED} Execution unit
AK Actuator unit
CA Container portion
ED Edge device
FG1, FG2 Field device
KE Edge device communication unit
KN1 First communication network
KN2 Second communication network
KO Logic/application component
MA Management portion
SE Sensor unit
SP Server platform

1-13. (canceled)

14. A system for resource administration in an installation of automation technology, comprising:
a server platform with a container portion, a management portion and an execution unit,
wherein the container portion comprises a plurality of logic/application components,
wherein each logic/application component contains algorithms or instructions for executing functions and wherein a logic/application component requires a minimum computing resource or memory resource to be executable on a device, and wherein the execution unit provides a defined computing resource or memory resource and is designed to instantiate or execute at least one logic/application component;
at least one field device, which is integrated in a field level of the installation in a first communication network, having at least one sensor unit and/or an actuator unit and an execution unit,
wherein the sensor unit is designed to capture a physical or chemical measured variable of a process-engineering process,
wherein the actuator unit is designed to influence a physical or chemical measured variable of a process-engineering process,
wherein the field device is designed to output as raw data the measured variable captured by the sensor unit and/or a manipulated variable of the actuator unit, and
wherein the execution unit provides a defined computing resource or memory resource and is designed to instantiate or execute at least one logic/application component;
an edge device, which is connected to the first communication network and which is directly or indirectly in communication with the server platform using a second communication network,
having a communication unit and an execution unit, wherein the communication unit is designed to exchange data between the edge device, the field device and the server platform,
wherein the execution unit provides a defined computing resource or memory resource and is designed to instantiate or execute at least one logic/application component, and
wherein the management portion of the server platform is designed, after selection by an operator, to assign one of the logic/application components to the field device, the edge device or the server platform, according to the minimum computing resource or memory resource required, and to load them onto this or these and to instruct them to instantiate the logic/application component.

15. The system of claim 14, wherein the sizes of the provided computing resources or memory resources, of the field device, of the edge device and of the server platform differ from one another, wherein the field device has the smallest size of the computing resources or memory resources provided and wherein the server platform has the largest size of the computing resources or memory resources provided.

16. The system of claim 14, wherein in the event that the logic/application components can also be instantiated on the edge device and/or on the field device apart from on the server platform, the operator will be given a selection option via the instantiating component.

17. The system of claim 14, wherein in the event that a logic/application component is to be instantiated on the field device or on the edge device, even though the field device or the edge device cannot provide the required minimum computing resource or memory resource, the management portion is designed to distribute the logic/application component among the execution units of the field device and of the edge device or of a plurality of field devices or of a plurality of edge devices and to cause them to be instantiated together.

18. The system of claim 14, wherein the management portion is configured to manage license information of the operator and to instantiate at least some of the logic/application components only for a specific time in accordance with the license information on the corresponding execution unit.

19. The system of claim 14, wherein in the event of an exchange or the new addition of an edge device and/or field device the management portion is designed to automatically assign corresponding logic/application components to the new edge device or field device, in particular analogously to the edge device or field device to be replaced or according to an operator profile.

20. The system of claim 14, wherein the first communication network is an Ethernet-based communication network or a field bus network of automation technology, or is based on the HART protocol, wherein the first communication network is designed to be wireless or wired.

21. The system of claim 14, wherein the edge device is in communication with the server platform by means of the Internet as a second communication network.

22. The system of claim 14, wherein the edge device is connected to an additional device via a data connection, in particular a wireless data connection, and wherein the additional device can be connected to the server platform by means of an Internet connection and is designed to establish the communication connection between the edge device and the server platform.

23. The system of claim 14, wherein the edge device with the server platform is in communication connection only at those times when a logic/application component is assigned to the edge device and/or the field device and wherein the communication connection is terminated after the assignment or the initiation of the instantiation.

24. The system of claim 14, wherein a plurality of versions of the same logic/application component is assigned to the corresponding execution unit of the edge device or of the field device, and wherein only that logic/application component which is released by the management portion of the server platform can be instantiated.

25. The system of claim 14, wherein the server platform is cloud-based, or is designed in accordance with cloud computing technology.

26. The system of claim 14, wherein a logic/application component executes one of the following logics or applications:
processing raw data of the field device, in particular calculating and/or evaluating envelope curves;
common processing of raw data of the field device and at least of one further field device;
logging raw data of the field device;
diagnostic functionalities;
communication components, in particular network-specific communication components;
parametrizations of the corresponding device, the execution unit of which instantiates or executes the logic/application component.
